(19) United States
(12) Patent Application Publication
(10) Pub. No.: US 2005/0263243 A1
(43) Pub. Date: Dec. 1, 2005

(54) Process for continuous manufacture of self-adhesive articles by coating incoming web-form materials with two-component polyurethanes

(75) Inventors: Uwe Schumann, Pinneberg (DE); Ulrike Wappler, Hamburg (DE); Ralf Hirsch, Quickborn (DE); Andreas Beckmann, Hamburg (DE); Andree Bernoth, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 11/113,487

(22) Filed: Apr. 25, 2005

Related U.S. Application Data
(63) Continuation-in-part of application No. 09/698,404, filed on Oct. 27, 2000.

(30) Foreign Application Priority Data
Oct. 28, 1999 (DE) 199 51 902.1

(51) Int. Cl. B32B 31/00; C09J 1/00; C09J 5/00; B32B 7/12

(52) U.S. Cl. 156/289; 156/247; 156/306.3

(57) ABSTRACT

A process for continuous production of self-adhesive articles, wherein a) one polyol component is placed in a container A and essentially one isocyanate component is placed in a container B, b) the polyol component and the isocyanate component are mixed in a mixer, c) the polyurethane composition thus mixed is applied to a backing material which is coated with a pressure-sensitive adhesive composition and moves optionally at constant speed, d) the laminate, comprising first backing material, pressure-sensitive adhesive composition and polyurethane composition, is passed through a heat tunnel, for a time which is less than that required for complete curing of the polyurethane, but sufficient for the curves of storage modulus (G′) and loss modulus (G″) of the polyurethane composition, as a function of curing time, to cross each other, e) the laminate is wound up in a winding station.

This application is a continuation-in-part of application Ser. No. 09/698,404 filed Oct. 27, 2000, now pending.

### BACKGROUND OF THE INVENTION

The present invention relates to a process for the continuous production of self-adhesive articles such as, for example, self-adhesive tapes by coating an incoming material in web form or two simultaneously incoming web-form materials, disposed with their surfaces parallel above but not in contact with one another, with a reactive, two-component polyurethane backing material, at least one of the incoming web-form materials having been treated with a pressure-sensitive adhesive composition (self-adhesive composition).

Single-sided self-adhesive articles comprise at least two layers (laminae), namely the backing layer, which is not self-adhesive, and the pressure-sensitive adhesive composition applied to it. A double-sided self-adhesive tape is generally composed of at least three layers, namely the backing layer and the pressure-sensitive adhesive layers applied to it on both sides. Exceptions are double-sided self-adhesive articles wherein backing and adhesive layer are identical (known as single-layer products).

The mechanical properties of an adhesive tape (for example, tensile strength, extensibility, elasticity) are essentially determined by the backing. The backing, moreover, largely determines the optical properties of an adhesive tape (transparency, color) and, in the case of a single-sided self-adhesive article, the surface properties of the side which is not self-adhesive (texture, roughness, surface tension). The backing material is also a co-determinant of the adhesion properties of a self-adhesive article.

Appropriate backing materials include all materials in web form, for example papers, wovens, nonwovens, films or elastomers, each with different thicknesses, textures and polymer compositions.

In combination with the respective backing that is used, the adhesive layer critically determines the adhesion properties of a self-adhesive article, which are manifested, inter alia, in shear stability times, bond strengths, tip-shear behavior, peel increase behavior, redetachability, et cetera.

The base polymers of modern pressure-sensitive adhesives include natural and synthetic rubbers, polyacrylates, block copolymers with polystyrene block fractions, polyethylene-vinyl acetates and polyurethanes, which are usually used in combination with additives such as resins and plasticizers and/or other auxiliaries such as, for example, antioxidants, UV stabilizers or rheological additives.

The widespread general process for producing adhesive tapes comprises coating a separately produced, web-form backing material with an adhesive composition. The coating operation is normally carried out from a solution, i.e., the pressure-sensitive adhesion composition is converted to a spreadable consistency, using solvents, prior to coating.

Alternatively, and depending on the polymer composition, coating may also be effected from the melt, without solvent, in an extrusion process. This process has become established in particular in the case of pressure-sensitive adhesives based on thermoplastic elastomers.

Moreover, the assembly of backing and pressure-sensitive adhesive composition may also be produced by first applying the pressure-sensitive adhesive composition to a dehesive medium and subsequently applying it to the backing in a laminating process.

The coating of web-form backing materials with pressure-sensitive adhesive compositions is very well established as a process for producing self-adhesive articles.

Nevertheless, there are a number of fundamental disadvantages which are disruptively manifested in particular in the case of adhesive tapes having high or very specific profiles of requirements. For instance, in many cases the anchoring of the adhesive composition on the backing is a problem and requires a further process step, namely coating with a primer (pre-coat). In the case of a double-sided adhesive tape, of course, this must be done on both sides, so resulting in a five-layer product structure. Moreover, there are occasionally no tailor-made backings available on the market, as are required for specific applications. In that case, either recourse is had to composite systems comprising individual backings, a further disadvantage of which is that they have to be joined using, for example, primer and adhesive systems, or else additional auxiliary layers are applied (for example, barrier layers preventing the migration of ingredients from the backing into the adhesive layer, or mirror layers for smoothing rough backing surfaces). All this results in increased complexity in the production process, and, ultimately, increased production costs.

In the text below, by way of example, a number of adhesive tapes from the comprehensive prior art are depicted, specifically those where polyurethanes or polyurethane films are used as the backing material.

WO 86/00536 A1 discloses a laminate comprising a polyurethane and a pressure-sensitive adhesive layer, the laminate being used for a pellet package and, respectively, administration form. A polyurethane film, without further treatment, is provided with a self-adhesive coating which envelopes a pellet and at the same time is bonded with the pellet to the skin of the user.

U.S. Pat. No. 5,127,974 A mentions a laminate comprising a polyurethane film with a self-adhesive coating. This laminate is used especially for the temporary protection of coated automobile surfaces.

DE 196 14 620 A1 and DE 197 33 014 A1 disclose a pressure-sensitive adhesive tape, coated on both sides with adhesive compositions, whose backing is formed by a formulated, crosslinked, unfoamed polyurethane.

Formulation constituents of the backing are a crosslinked, unfoamed polyurethane, fillers, and, if desired, further auxiliaries.

According to DE 196 14 620 A1, the polyurethane content of the backing is up to 50% by weight, preferably from 30% by weight to 40% by weight, the polyurethane being plasticizer-free. The fillers account for from 50% by weight to 70% by weight of the backing.

According to DE 197 33 014 A1, the polyurethane content of the backing is up to 50% by weight, preferably from 10% by weight to 40% by weight. The fillers account for from 40% by weight to 70% by weight of the backing, while the plasticizers and resins together are used at from 5% by weight to 30% by weight, in particular from 10% by weight to 25% by weight.

In U.S. Pat. No. 6,129,983 a reactive polyurethane is applied to an adhesive. A second adhesive layer is laminated to the polyurethane. Then the polyurethane is cured at temperatures up to 120° C. This curing time takes up to 30 minutes and is followed by a final curing at room temperature, which takes up to one week. The laminate is not wound up at any time and one would expect that winding up would not possible within a continuous coating process, but only after a certain period of time, such as, for example three days to one week. There are several reasons for this. The process of winding up would subject the material to a compressive stress and a tensile stress. The polyurethane, on the other hand, is not completely hardened when it reaches the end of the heating tunnel, which is the point at which it would be wind up if such winding up were possible. However, the polyurethane at this point has a consistence between that of a paste and that a rubber. Such a rubbery paste-like material could not be wound up.

Furthermore the rubbery paste-like polyurethane is in direct contact with pressure sensitive adhesive layers on both sides, both of which have a viscoelastic character. One can expect that there would be a flow between these adhesives and the polyurethane into each other, with the result that it is impossible to wind up this laminate. Also, it would be necessary, to remove one of the two release liners carrying the pressure sensitive adhesives before winding up the laminate. Otherwise wrinkles and waves would form in the roll. One can also expect that it would not be possible to remove one of the two liners from the pressure sensitive adhesive, because the pressure sensitive adhesive is in direct contact with the rubbery paste-like polyurethane. It would be expected that the surface will not be smooth afterwards.

It is an object of the present invention to provide a process with which self-adhesive articles may be produced and wound up continuously without the need to produce separately the web-form backing material of the self-adhesive article and then coat it with an adhesive composition, directly or by a laminating process, so that the fundamental disadvantages of the conventional production processes for adhesive tapes are unable to occur in the form. The backing is to be distinguished by a profile of properties which can be adjusted variably and diversely.

The invention accordingly provides the process described below for continuous production and winding up of self-adhesive articles whose backing comprises a polyurethane as base polymer.

### SUMMARY OF THE INVENTION

The process of the invention is composed of the following individual steps:
a) a polyol component is placed in a container A and an isocyanate component is placed in a container B.
b) The polyol component and the isocyanate component are mixed in a mixer.
c) The polyurethane composition thus mixed is applied to a backing material which is coated with a pressure-sensitive adhesive composition and moves preferably at constant speed.
d) The laminate, comprising backing material, pressure-sensitive adhesive composition and polyurethane composition, is passed through a heat tunnel, for a time which is less than that required for complete curing of the polyurethane, but sufficient for the curves of storage modulus (G′) and loss modulus (G″) of the polyurethane composition, as a function of curing time, to cross each other.
e) The laminate is finally wound in a winding station.

### DETAILED DESCRIPTION OF THE INVENTION

In accordance with the present invention, degree of curing is controlled by rheological methods. The storage modulus (G′) and the loss modulus (G″) are measured, both as a function of the curing time, by the DMA-method (Dynamic Mechanical Analysis). G′ represents the elastic quota of the polymer, G″ the viscous quota. In the course of the curing G′ increases and G″ increases, too, but less fast than G′. As soon as both curves overlap, i.e. at the moment of crossover, the polyurethane has reached the state which allows winding it up. This state has been reached after approximately 5 to 30 minutes, depending on the curing temperature, the amount of catalyst and special types of isocyanates and polyols used.

The complete curing, on the other hand, takes at least 3 days, sometimes up to 7 days. When curing is finished, G′ and G″ do not change any more.

In a preparation step, the backing material is treated on both sides, or in particular on one side, with a pressure-sensitive adhesive composition. This treatment takes place in a customary coating process, either from a solution or from the melt.

The backing material may be a dehesive medium, for example, a release paper or a release film. Alternatively, it may comprise any desired other backing material, for example, a paper, a woven, a nonwoven, a film or an elastomer, which after the last process step constitutes part of the overall backing of the self-adhesive article.

Where the backing material is a dehesive medium, the polyurethane composition is applied to the backing material coated with a pressure-sensitive adhesive composition, said application taking place such that the polyurethane composition is present on the pressure-sensitive adhesive composition.

Where the backing material is not a dehesive medium, the polyurethane composition is applied preferably to that side of the backing material on which there is no pressure-sensitive adhesive composition. Alternatively, however, in this case as well the poly-urethane composition may be applied to the pressure-sensitive adhesive composition. If so, a further layer of adhesive should be applied to the outer face of the backing material.

In another preferred embodiment of the process, a second backing material is supplied at preferably constant speed to the polyurethane composition of the laminate.

In another preferred embodiment of the process, the second backing material has been treated with a pressure-sensitive adhesive composition.

In this case, an additional preparation step is necessary, in which the first preparation step is repeated accordingly, neither the pressure-sensitive adhesive composition nor the web-form material necessarily being identical with those from the first preparation step. If desired, after the heating tunnel, the second backing material is peeled off.

Also advantageous are further containers upstream of the mixer, containing catalysts, plasticizers, dyes and other additives, which may be introduced and added.

Coating with the reactive, two-component polyurethane onto the first backing material takes place preferably on a standard coating unit for the production of adhesive tapes.

### BRIEF DESCRIPTION OF THE DRAWINGS

FIG. 1 depicts a preferred embodiment of a coating unit for the production of adhesive tapes.

FIG. 2 illustrates the Maxwell model for the combination of the elastic and the viscous properties of a system.

FIG. 3 illustrates the Kelvin/Voigt model for the combination of the elastic and the viscous properties of a system.

FIG. 4 illustrates the stress and strain curves for an ideal viscous system.

FIG. 5 is another illustration of the stress and strain curves for an ideal viscous system.

FIG. 6. illustrates the DMA (Dynamic Mechanical Analysis) method.

FIG. 7 illustrates typical DMA-curves of two different polyurethane formulations (examples) while curing.

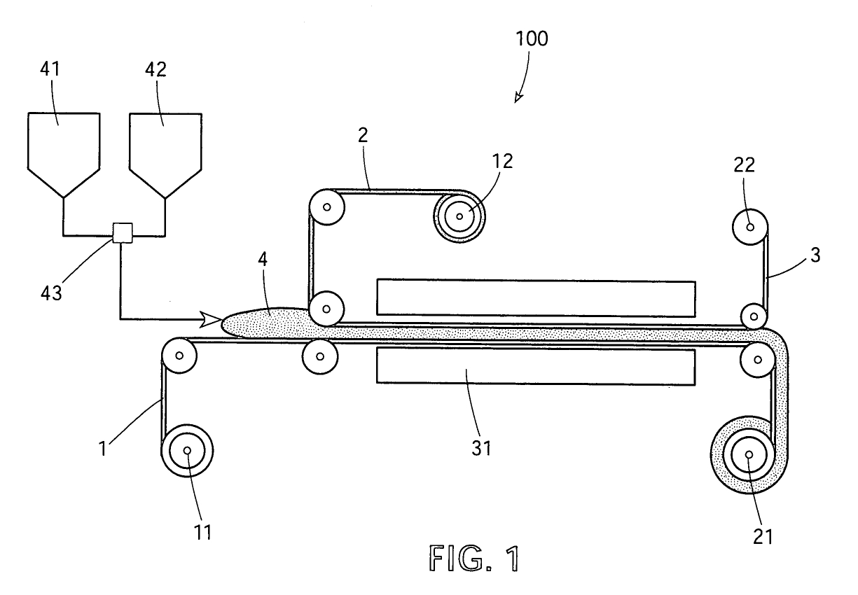

Referring to FIG. 1, the unit 100 possesses two bale unwinders 11, 12 for the incoming materials 1 and 2, and also a product winding station 21 and a bale winder 22 for any auxiliary material 3 that may become uncovered. Moreover, the unit 100 has a heating tunnel 31 in which the polyurethane composition 4 is cured.

The incoming, web-form materials 1 and 2 are guided so that the coating of the polyurethane composition 4 may take place directly in the gap between the two materials 1 and 2. The gap width is variable and freely adjustable.

Behind the gap, a web guide, not shown here, for the second backing material 2, via a belt, is advantageous with regard to the achievement of a good constancy of thickness of the polyurethane backing material 4.

In the case of a single-sided self-adhesive article, the upper bale unwinder and the bale winder for the auxiliary material 3 to be uncovered may, if appropriate, be omitted.

Alternatively, a dehesive material may be used whose function is merely to keep the shaft and the reactive polymer from coming into contact with one another, in order to avoid instances of curing of the polyurethane on the shaft.

The reactive polyurethane backing composition 4 is prepared continuously, directly before its application, from two components which react chemically with one another, namely a generally preformulated polyol component (A) and an isocyanate component (B), both of which are present in containers 41 and 42, respectively, preparation taking place in a mixing head (dynamic mixer) or a mixing pipe (static mixer) of a standard two-component mixing and metering unit 43, and are applied directly between the incoming, web-form materials 1 and 2.

A suitable two-component mixing and metering unit 43 is any corresponding standard commercial unit which is suitable for casting and is designed for short pot lives of generally less than one minute. It may be actualized either in a static system or else in a dynamic mixing system. In order to be able to coat the full width of the incoming materials 1 and, if appropriate, 2 with the polyurethane backing material 4, it is advantageous to install the mixing head or the mixing pipe such that it is movable on a traversing device, which then permanently travels the width of the incoming materials, in an oscillating manner.

In the subsequent heating tunnel section 31, the reactive polyurethane composition 4 cures to the desired backing material and, in general, attaches chemically to the incoming materials, i.e., in particular, adhesive coatings. Attachment to an acrylate takes place, for example, through the formation of a carboxamide. After the tunnel section 31, the finished product is wound up.

The heating tunnel section 31 is held preferably at temperatures between 20° C. and 120° C.

The equation for the chemical reaction to the polyurethane is:

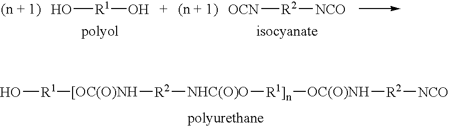

The polyol component is liquid and the isocyanate component is liquid, as well. The mixed composition of the two components is also liquid when it is applied to the backing material. However, the mixed composition immediately begins to react according to the equation. This means that the viscosity of the mixed composition increases by the time while passing through the heat tunnel. When the mixed composition has reached the end of the heat tunnel, i.e. when curing has taken place for a certain time and the material has to be wound up it is no longer a liquid but it is also neither a solid nor an elastic material, because curing is not completed at that time. It is something between a highly viscous liquid and an elastic material. It is a viscoelastic material.

Viscoelastic properties are described by Theological theories and terms.

When an ideal elastic system is deformed under an external force, the energy is fully stored. The energy is released when the external force is removed. The force in this case is proportional to the deformation (strain).

This system is described by the Hook equation:
σ=Gγ
σ is the shear stress, G is the shear modulus and γ is the shear deformation.

When an ideal viscous system is deformed under an external force, the energy is fully lost. The force in this case is proportional to the velocity of the system but is independent of the deformation.

This system is described by the equation of Newton:
σ=ηdγ/dt
σ is the shear stress, η is the viscosity and dγ/dt is the shear rate.

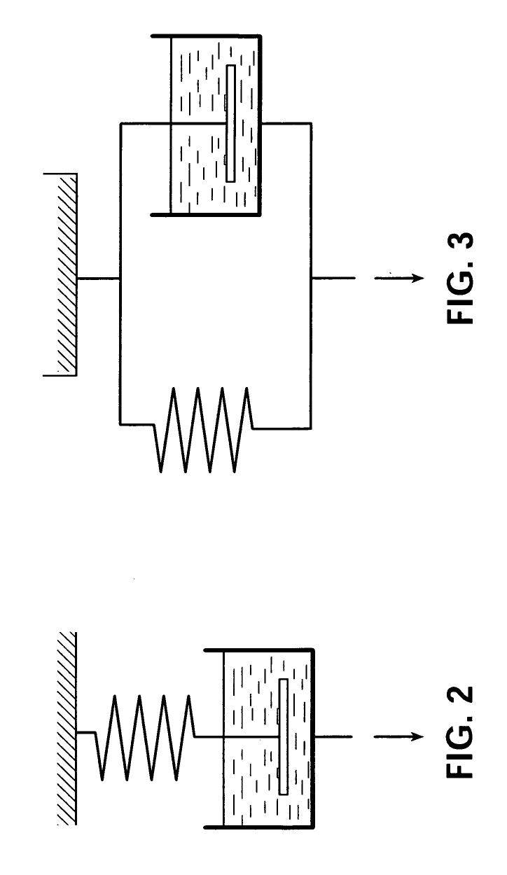

Several models have been proposed for the combination of the elastic and the viscous properties of a system. Well known are those combining an elastic spring and a viscous dashpot, such as the Maxwell model shown in FIG. 2, and the Kelvin/Voigt model, shown in FIG. 3.

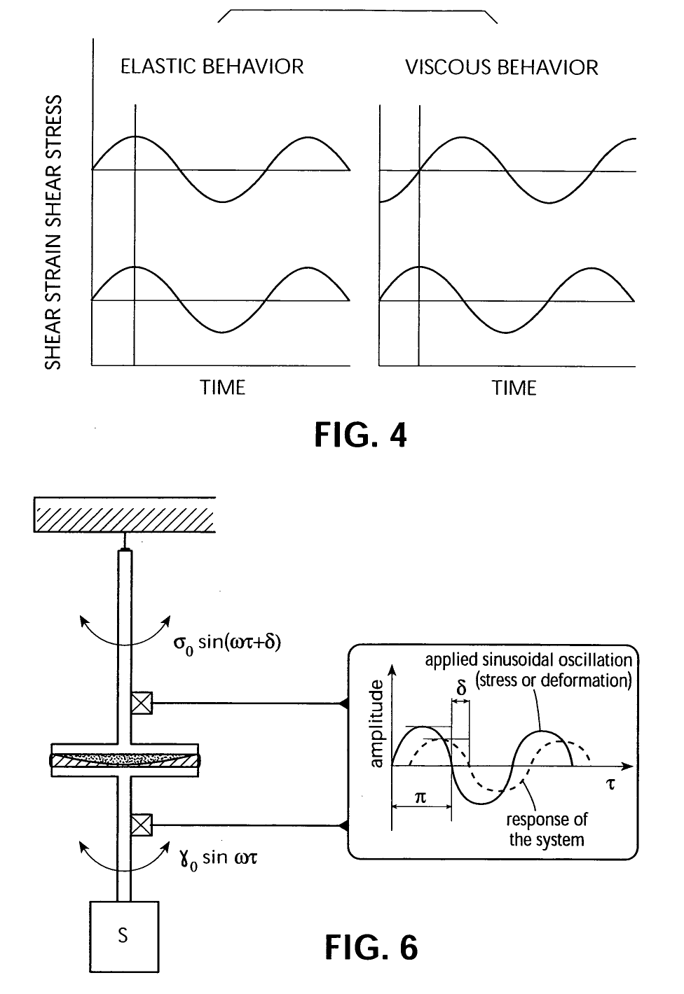

To measure the dynamic rheological properties of a viscoelastic system, the effect of oscillation on the shear stress is studied. For an ideal elastic system, the stress curve will follow the strain curve in phase and the phase angle will be 0°. For an ideal viscous system, the stress will not follow the strain curve and will be 90° out of phase, as seen in FIG. 4.

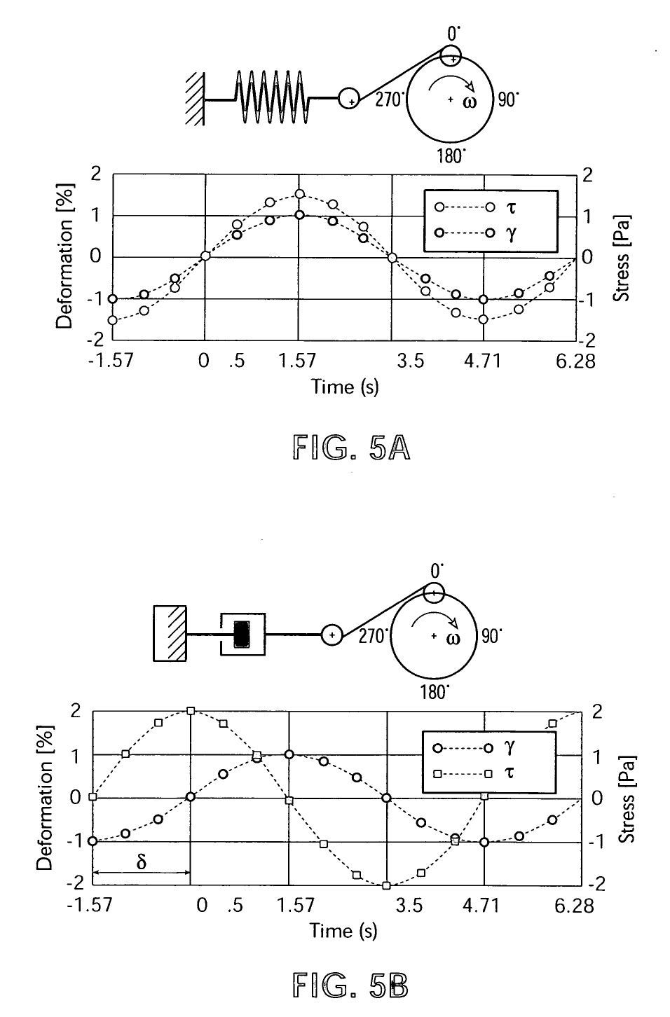

Another illustration is given in FIG. 5.

A viscoelastic system will therefore have a phase angle between 0° and 900.

The closer the angle is to 0°, the more elastic is the material, while the closer the angle is to 90°, the more viscous is the material.

When a viscoelastic material is stressed sinusoidally at a frequency f, the complex strain may be described as:
γ*=γ₀e^{iωt}
where ω is the angular frequency (w=2π, t is the time, and i=√−1

The complex stress may be represented as
σ*=Γ₀e^{i(ωt+δ)}
where δ (delta) is the phase angle.

The complex strain and complex stress are vectors in complex planes. They may be resolved into real and imaginary components as follows:
γ*=γ′+iγ″
σ*=σ′+iσ″
and the complex shear modulus is defined as
G*=σ*/γ*=(σ₀/γ₀)e^{iδ}

The complex modulus includes the elastic portion and the viscous portion of the rheological behavior, as well as the phase angle between these two:
G*=G′+iG″
where G′ is the storage modulus and G″ is the loss modulus.

The absolute magnitude of the complex modulus is
|G*|=\sqrt{(G′²)+(G″²)}

The components of the complex modulus are
G′=|G*|cos δ
G″=|G*|sin δ
or
G′=(σ₀/γ₀)cos δ
G″=(σ₀/γ₀)sin δ

And the phase angle δ (delta) may be calculated from the relationship:
tan δ=G″/G′

Tan δ is therefore a way to describe the ratio of energy lost to energy stored.

The DMA (Dynamic Mechanical Analysis) method is illustrated by FIG. 6.

In the DMA method, the viscoelastic material is placed between a cone and a plate. A parallel plate configuration is also possible.

The principle of the method is as follows: The viscoelastic material is stressed sinusoidally at a frequency f. S in the illustration is the exciter for the oscillation. The response of the system depends on what is put into it:

Either a deformation as a function of time is given (γ(t)) and the response is the shear stress as a function of time (σ(t)) as well as the phase angle δ or σ(t) is given and the response is γ(t) as well as the phase angle δ.

From these data G′, G″ and tan δ can be calculated, usually with the aid of a computer.

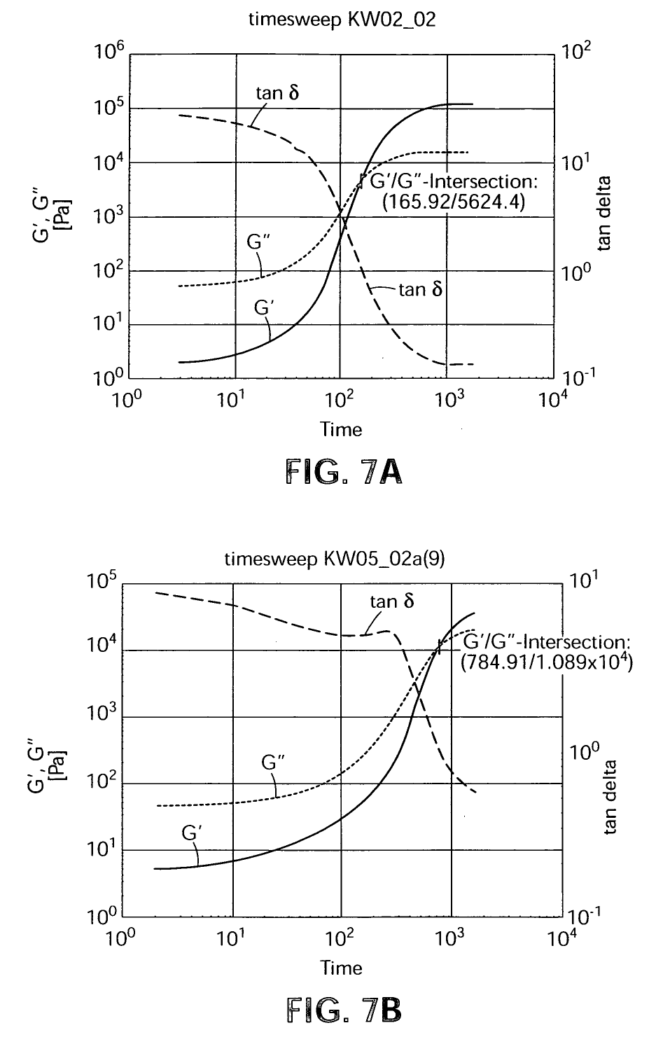

FIG. 7 shows typical DMA-curves of two different polyurethane formulations (examples) while curing.

The x-axis represents the curing time of the polyurethane. The y-axis represents G′ (blue), G″ (green) and tan δ (red).

The cross-over is the cross between G′ and G″. As can clearly be seen, curing is not completed at that time, because G′ and G″ are still increasing and tan δ is still decreasing.

Surprisingly, at the time of cross-over, the tape can be wound up and/or the liner can be removed from the tape without adverse results, even though curing of the polyurethane has not been completed.

In the case of a double-sided adhesive tape, a three-layer product structure is obtained, comprising adhesive composition, polyurethane backing, and adhesive composition. There is no need for a primer, nor for any other additional layer. The backing thickness is easily adjusted by way of the gap width on the applicator unit. Since the polyurethane components (A) and (B) contain no solvent, even very thick backings can be produced without bubbles using this process.

In one possible embodiment, the backing has a thickness of from 0.1 to 50 mm, preferably from 0.4 to 20 mm. The adhesive composition preferably has an application weight of from 10 g/m² to 100 g/m².

Suitable polyurethane backing materials are all materials which comprise a polyurethane as base polymer and may be prepared in a two-component mixing process. The diversity of polyurethane chemistry, resulting both from the fullness of the polyurethane building blocks provided by the chemical base-materials industry and from the diverse possibilities of compounding with fillers, resins, plasticizers, other polymers, for example, epoxides, acrylates, natural and synthetic rubbers, ethylene-vinyl acetates, block copolymers with polystyrene block fractions, and other additives such as aging inhibitors, UV stabilizers or rheological additives, for instance, makes it possible to use this process to provide self-adhesive articles tailored to many fields of application.

Also suitable as the polyurethane backing material are all foamed materials which comprise a polyurethane as base polymer and may be prepared in a multicomponent mixing process. The foam structure may be achieved either chemically, for example, by means of an isocyanate/water reaction initiated during the mixing operation, or by blowing agents, or else physically, by the introduction of a gas (for example, nitrogen or air). The gas may be introduced both during the preparation of the A or B component and directly at the mixing head of a multicomponent mixing and metering unit. The gas introduced into the mixing head represents, so to speak, the special case of a third component.

Express reference may be made to the depiction of the state of the art polyurethane chemistry in “Kunststoff-Handbuch” 7, Polyurethane, Becker/Braun (1993).

One possible embodiment of the backing comprises as formulation constituents a crosslinked, unfoamed polyurethane, fillers, and, if desired, further auxiliaries.

The polyurethane content of the backing is up to 50% by weight, preferably from 30% by weight to 40% by weight, the polyurethane being plasticizer-free. The fillers account for from 50% by weight to 70% by weight of the backing.

The isocyanate component of the polyurethane is selected in accordance with the specific properties to be established in the backing. Suitable examples include tolylene diisocyanate, diphenylmethane 4,4′-diisocyanate, dicyclohexylmethane 4,4′-diisocyanate, hexamethylene diisocyanate, isophorone diisocyanate, mixtures of the aforementioned isocyanates or isocyanates derived chemically therefrom, for example, dimerized or trimerized types.

The isocyanate-reactive component is likewise selected in accordance with the properties of the backing, which are to be established as a function of the desired profile of requirements. Suitable examples include all polyester diols, triols and polyols, polyether diols, triols and polyols, polyether diamines, triamines and polyamines, hydroxyl-functionalized polybutadiene, and also all monohydric alcohols (mono-ols), monofunctional amines (mono-amines), polyether mono-ols, polyether mono-amines, or products derived from the four last-mentioned groups.

It has been found advantageous if the hydroxyl-functionalized polybutadienes, the polyester diols, the polyester triols, the polyester polyols, the polyether diols, the polyether triols, the polyether polyols, the polyether diamines, the polyether triamines, or the polyether polyamines have a molecular weight M_{w}≧1000 g/mol.

In addition to the isocyanate components recited above and the components which react with them, however, it is also possible to use other starting materials to form the polyurethane, without departing from the concept of the invention.

In order to accelerate the reaction between the isocyanate component and the isocyanate-reactive component, it is possible to use all catalysts known to the skilled worker, such as, for example, tertiary amines or organotin compounds.

Polyurethanes as described above are mentioned, for example, in “Ullmann's Encyclopedia of Industrial Chemistry, Vol. A21: Polyurethanes”.

In one particularly preferred embodiment, an NCO/OH ratio of from 1.0 to 1.3 is established in order to form the polyurethane, preferably from 1.0 to 1.1.

The preferred mono-ol OH content as a proportion of the overall OH content, i.e., the preferred chain-terminating component, is between 5% and 40%, in particular between 10% and 30%.

Fillers which may be used include both reinforcing types, such as carbon black, for example, and nonreinforcing types, such as chalk or barium sulfate, for example. Further examples are talc, mica, pyrogenic silica, silicates, zinc oxide, microballoons, solid glass microbeads, hollow glass microbeads, and/or plastic microbeads of all kinds. Mixtures of the materials mentioned may also be used.

The microballoons comprise elastic, thermoplastic hollow beads which have a polymer shell. These beads are filled with low-boiling liquids or with liquefied gas. Suitable shell polymers are, in particular, acrylonitrile, PVDC, PVC or acrylates. Hydrocarbons such as the lower alkanes, for example, pentane, are suitable as a low-boiling liquid, while a suitable liquefied gas is a chemical such as isobutane.

Particularly advantageous properties are in evidence when the microballoons involved are those having a diameter at 25° C. of from 3 μm to 40 μm, in particular from 5 μm to 20 μm.

On exposure to heat, the capsules expand irreversibly and three-dimensionally. Expansion is at an end when the internal pressure equals the external pressure. In this way, a closed-cell foam backing is obtained which features good flow behavior and high recovery forces.

Following thermal expansion due to elevated temperature, the microballoons advantageously have a diameter of from 20 μm to 200 μm, in particular from 40 μm to 100 μm.

To enhance the stability of the polyurethane with respect to aging, it may be blended with customary aging inhibitors, which depending on the application in point may come from the class of the discoloring or nondiscoloring aging inhibitors, in the range between 0% by weight and 5% by weight, and also known light stabilizers, in the range between 0% by weight and 5% by weight, or ozone protectants, in the range between 0% by weight and 5% by weight.

To achieve freedom from bubbles, furthermore, it is possible to admix siccatives, such as calcium oxide or molecular sieve zeolites, for example, to the formulation, in particular in the range between 0% by weight and 10% by weight.

Depending on the intended use, all of the abovementioned auxiliaries may be used, either alone or in any desired combination, to prepare the polyurethane composition, in order to tailor it optimally to the use. The use of these additives also enables the composition to be colored black, as required in particular by the automotive industry, without problems.

The A and B components are either purchased directly or prepared from individual purchased components in accordance with customary mixing or preparation processes which accord with the prior art, for example, depending on rheological setting and filler content, in a stirred vessel, in a planetary mixer, or in a dissolver.

The particular feature of the process of the invention is the inverted nature of the coating operation.

Instead of the usual application of a pressure-sensitive adhesive composition to a backing, a reactive, initially liquid backing material is instead applied to a pressure-sensitive adhesive composition which has already been introduced, or, if appropriate, to other incoming materials, of which at least one has been treated with a pressure-sensitive adhesive composition.

One advantage of the process is to be able to achieve effective anchoring between the polyurethane backing material and the incoming, web-form materials, i.e., for example, the pressure-sensitive adhesive composition, without the need to use primers or similar auxiliary layers. This is the case because, at the time of coating, the polyurethane backing material is reactive, owing to isocyanate which has not yet immediately reacted, and therefore undergoes spontaneous chemical attachment to numerous substrates.

Another advantage is the simplicity of the process, which makes it possible to produce self-adhesive articles in no more than three coating steps (preparation of the incoming material 1, preparation if appropriate of the incoming material 2, coating with the polyurethane backing material) with particular cost advantages, even when said articles are of complex construction, i.e., comprising a composite backing.

Following the coating operation with the two-component polyurethane, no further coating or laminating step is necessary to produce the self-adhesive article.

A further advantage of the process is the ability to produce a particular diversity of self-adhesive articles. This diversity arises from the diverse possibilities of polyurethane chemistry, as depicted above, and from the diverse possibilities in respect of the incoming materials 1 and 2.

The invention will be described more closely on the basis of the following examples, without wishing thereby to restrict the invention.

The following test methods were used to characterize briefly the specimens produced in accordance with the process described:
The bond strength was determined in accordance with BDF JOPMA002.

In accordance with this method, the adhesive tape specimen for testing was applied to the substrate (steel) and then peeled off under defined conditions in a tensile testing machine. The peel angle was 180°, the peel speed 300 mm/min. The force required for peel removal is the bond strength.
The tensile strength and elongation at break were determined in the tensile test in accordance with BDF JOPMC001.

In this test, a test strip 100 mm in length and 25 mm in width was stretched in the lengthwise direction in a tensile testing machine at defined clamp speed (300 mm/min) until it tore. The parameters measured were the tensile strength, based on the cross section of the sample, and the extension at the point of tear.
The compressive strength was determined in accordance with DIN 53577.

The compressive strength is the compression strain determined at a defined deformation (in the Examples 14%) during the stress operation. It was measured in a compressive testing machine. The dimensions of the test specimens were 30 mm×30 mm×15 mm (L×W×H). The height of the test specimens was produced by stacking the adhesive strips.

The Theological measurements were conducted by using the Dynamic Stress Rheometer (DSR)SR 200N from the company Rheometric Scientific.

The temperature and time required for the two curves (G′ and G″) to cross were measured by Dynamic Time Sweeps.

In these tests the stress was set to 200 Pa, the frequency was set to 10 rad/s.

A plate/plate configuration was used and the distance between the plates (=thickness of the samples) was set to 1.5 mm. The temperature was varied between 60° C. and 100° C. The result was the time required for the two curves (G′ and G″) to cross, depending on the temperature of the plates.

Coating in the examples was carried out on a unit from the company Pagendarm. The unit possessed the unwinding and winding facilities shown in FIG. 1 for the incoming materials 1 and 2 with a web width of 50 cm. The coating gap width was variably adjustable between 0 and 1 cm. The length of the heating tunnel was approximately 12 m. The temperature in the heating tunnel was divisible into four zones and freely selectable in each case between room temperature and 120° C.

In the examples the temperature of the heating tunnel and the coating speed were set in such a way that the laminates were heated in the tunnel for the period of time required for the two curves (G′ and G″) to cross. This period of time was determined by the rheological measurements before.

A two-component mixing and metering unit from the company Spritztechnik-EMC was used. The mixing system was dynamic. The mixing head was designed for two liquid and a third gaseous component. The mixing rotor had a variable speed of up to approximately 5000 rpm max. The metering pumps of this unit were toothed-wheel pumps having a maximum output of approximately 2 l/min.

The A components were prepared in an evacuable dissolver from the company Drais.

### EXAMPLES

### Example 1

To produce a special masking tape, which is used following the application of the first coat (cathodic electrocoat) to mask off the window flange joints during the coating process in the OEM production of automobiles, and so protect them against further coats which are baked at temperatures of up to 180° C., the process was used as follows:

1st Process Step (Preparation Step), Production of the Incoming Material 1:

A 23 μm thick polyester film (polyethylene terephthalate) was coated in a customary coating process with a known natural rubber-based pressure-sensitive adhesive composition comprising

| | |
|---|---|
| 48% | natural rubber CV50 |
| 23% | poly-beta-pinene resin |
| 5% | terpene phenolic resin |
| 3% | rosin |
| 7% | copolymer of acrylonitrile and butadiene |
| 8% | zinc oxide |
| 5% | reactive alkyiphenol resin, and |
| 1% | 2,5 di(tert-amyl)hydroquinone |

from a solution in an application thickness of approximately 25 μm and, during winding, was lined with a standard commercial release paper.
2nd Process Step, Polyurethane Coating:

In the 2nd process step, the polyester film treated with the pressure-sensitive adhesive composition was coated from the nonadhesive side with a devolatilized, two-component polyurethane backing composition at a rate of 1 m/min. The application thickness was 120 μm. Curing was effected at a tunnel temperature of 80° C. The heating time was 14 minutes (corresponds to crossover-time of G′ and G″).

The makeup of the polyurethane backing composition was as follows:

| | | Weight fraction |
|---|---|---|
| | Raw material | [% by weight] |
| A component | Arcol 1030 ® | 30.0 |
| | Arcol 1074 ® | 10.0 |
| | Dibutyltin dilaurate | 0.2 |
| | Calcium oxide | 5.0 |
| | Bayferrox 3920 ® | 1.0 |
| | Omyacarb 4BG ® | 28.3 |
| B component | Vestanat IPDI ® | 25.5 |

The resultant adhesive tape had a tensile strength of 30.3 N/mm² with an elongation at break of 43.4%. The bond strength on steel was 4.9 N/cm.

The adhesive tape was overpaintable and was sufficiently temperature-stable in view of the paint baking conditions.

### Example 2

To produce a special masking tape, which is used as in Example 1 following the application of the first coat (CED coating material) to mask off the window flange joints during the coating process in the OEM production of automobiles, and so protect them against further coats which are baked at temperatures of up to 180° C., and which is also so flexible that it can easily be stuck on in curves, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to standard commercial double-sided release paper, dried, crosslinked and subsequently wound up.

2nd Process Step, Polyurethane Coating:

In the 2nd process step, the acrylate pressure-sensitive adhesive composition applied to the release paper was coated directly with a devolatilized, two-component polyurethane backing composition at a rate of 3 m/min. The application thickness was 250 μm. Curing was effected at a tunnel temperature of 60 to 70° C. The heating time was 7 minutes (corresponds to crossover-time of G′ and G″).

The makeup of the polyurethane backing composition was as follows:

| | | Weight fraction |
|---|---|---|
| | Raw material | [% by weight] |
| A component | Poly THF 250 ® | 14.3 |
| | Poly THF 650 ® | 37.6 |
| | Dibutyltin dilaurate | 0.1 |
| | Calcium oxide | 10.0 |
| | Bayferrox 3920 ® | 1.3 |
| | Aerosil R 202 ® | 2.0 |
| B component | Desmodur CD ® | 34.7 |

The resultant adhesive tape had a tensile strength of 20.0 N/mm² with an elongation at break of 195%. The bond strength on steel was 2.5 N/cm. The adhesive tape was overpaintable and was sufficiently temperature-stable in view of the paint baking conditions, and could be stuck on in curves.

### Example 3

To produce an elastic, sandblast-resistant, punchable adhesive stencil tape, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to standard commercial double-sided release paper, dried, crosslinked and subsequently wound up.

2nd Process Step, Polyurethane Coating:

In the 2nd process step, the acrylate pressure-sensitive adhesive composition applied to the release paper was coated directly with a devolatilized, two-component polyurethane backing composition at a rate of 3 m/min. The application thickness was 875 μm. Curing was effected at a tunnel temperature of 60 to 70° C. The heating time was 12 minutes (corresponds to crossover-time of G′ and G″).

The makeup of the polyurethane backing composition was as follows:

| | | Weight fraction |
|---|---|---|
| | Raw material | [% by weight] |
| A component | Arcol 1042 ® | 29.0 |
| | Dibutyltin dilaurate | 0.1 |
| | Omyacarb 4BG ® | 63.1 |
| | Calcium oxide | 5.0 |
| B component | Desmodur CD ® | 2.8 |

The resultant adhesive tape had a tensile strength of 1.7 N/mm² with an elongation at break of 124%. The bond strength on steel was 2.5 N/cm. The adhesive tape was sufficiently resistant to sandblasting, and was readily punchable.

### Example 4

To produce a sandblast-resistant, punchable adhesive stencil tape of low extensibility at low applied force, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to standard commercial slightly creped paper backing with a basis weight of 68 g/m², dried, crosslinked and, during winding up, was lined with a standard commercial release paper.

2nd Process Step, Polyurethane Coating:

In the 2nd process step, the slightly creped paper backing treated with the pressure-sensitive adhesive composition was coated from the nonadhesive side with a devolatilized, two-component polyurethane backing composition at a rate of 3 m/min. The application thickness was 850 μm. Curing was effected at a tunnel temperature of 60 to 70° C. The heating time was 12 minutes (corresponds to crossover-time of G′ and G″). The makeup of the polyurethane backing composition was as follows:

| | | Weight fraction |
|---|---|---|
| | Raw material | [% by weight] |
| A component | Arcol 1042 ® | 29.0 |
| | Dibutyltin dilaurate | 0.1 |
| | Omyacarb 4BG ® | 63.1 |
| | Calcium oxide | 5.0 |
| B component | Desmodur CD ® | 2.8 |

The resultant adhesive tape was sufficiently resistant to sandblasting, and was readily punchable. The bond strength on steel was 2.1 N/cm.

### Example 5

To produce a sandblast-resistant, punchable adhesive stencil tape of low extensibility at low applied force, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to a standard commercial polyester (polyethylene terephthalate) film with a thickness of 23 μm, dried, crosslinked and, during winding up, was lined with a standard commercial release paper.

2nd Process Step, Polyurethane Coating:

In the 2nd process step, the polyester film treated with the pressure-sensitive adhesive composition was coated from the nonadhesive side with a devolatilized, two-component polyurethane backing composition at a rate of 3 m/min. The application thickness was 850 μm. Curing was effected at a tunnel temperature of 60 to 70° C. The heating time was 12 minutes (corresponds to crossover-time of G′ and G″).

The makeup of the polyurethane backing composition was as follows:

| | | Weight fraction |
|---|---|---|
| | Raw material | [% by weight] |
| A component | Arcol 1042 ® | 29.0 |
| | Dibutyltin dilaurate | 0.1 |
| | Omyacarb 4BG ® | 63.1 |
| | Calcium oxide | 5.0 |
| B component | Desmodur CD ® | 2.8 |

The resultant adhesive tape was sufficiently resistant to sandblasting, and was readily punchable. The bond strength on steel was 2.8 N/cm.

### Example 6

To produce an elastic masking tape which is easy to stick on in curves and is suitable for general painting and decorating work, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to standard commercial double-sided release paper, dried, crosslinked and then wound up.

2nd Process Step, Polyurethane Coating:

In the 2nd process step, the acrylate pressure-sensitive adhesive composition applied to the release paper was coated directly with a devolatilized, two-component polyurethane backing composition at a rate of 3 m/min. The application thickness was 300 μm. Curing was effected at a tunnel temperature of 60 to 70° C. The heating time was 12 minutes (corresponds to crossover-time of G′ and G″).

The makeup of the polyurethane backing composition was as follows:

| | | Weight fraction |
|---|---|---|
| | Raw material | [% by weight] |
| A component | Arcol 1074 ® | 31.5 |
| | Lutensol A07 ® | 3.3 |
| | Dibutyltin dilaurate | 0.1 |
| | Calcium oxide | 7.9 |
| | Omyacarb 4BG ® | 53.9 |
| B component | Desmodur CD ® | 3.3 |

The resultant adhesive tape had a tensile strength of 2.1 N/mm² with an elongation at break of 194%. The bond strength on steel was 2.5 N/cm. The adhesive tape was overpaintable and could be stuck on in curves.

### Example 7

To produce an adhesive edge-protection tape, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to a woven backing made from closely woven polyester (20×20 threads per cm in warp and weft direction, metric count: 34, basis weight>130 g/m²), dried, crosslinked and, during winding up, was lined with a standard commercial release paper.

2nd Process Step, Polyurethane Coating:

In the 2nd process step, the woven fabric treated with the pressure-sensitive adhesive composition was coated from the nonadhesive side with a devolatilized, two-component polyurethane backing composition at a rate of 3 m/min. The application thickness was 400 μm. Curing was effected at a tunnel temperature of 60 to 70° C. The heating time was 12 minutes (corresponds to crossover-time of G′ and G″).

The makeup of the polyurethane backing composition was as follows:

| | | Weight fraction |
|---|---|---|
| | Raw material | [% by weight] |
| A component | Arcol 1042 ® | 29.0 |
| | Dibutyltin dilaurate | 0.1 |
| | Omyacarb 4BG ® | 63.1 |
| | Calcium oxide | 5.0 |
| B component | Desmodur CD ® | 2.8 |

The resultant adhesive tape had a tensile strength of 19.1 N/mm² with an elongation at break of 24%. The bond strength on steel was 2.9 N/cm.

### Example 8

To produce a particularly cost-effective adhesive edge-protection tape, the process was used as follows:

1st Process Step (Preparation Step), Production of the Incoming Material 1:

A solvent-based acrylate pressure-sensitive adhesive composition consisting of butyl acrylate (47.5%), ethylhexyl acrylate (47.5%), glycidyl methacrylate (2%), acrylic acid (3%), and small amounts of a known crosslinker was applied in an application thickness of 40 g/m² to a 150 μm thick spunbonded polyester nonwoven with a basis weight of 70 g/m², dried, crosslinked and, during winding up, was lined with a standard commercial release paper.

2nd Process Step, Polyurethane Coating:

In the 2nd process step, the spunbonded nonwoven treated with the pressure-sensitive adhesive composition was coated from the nonadhesive side with a devolatilized, two-component polyurethane backing composition at a rate of 3 m/min. The application thickness was 400 μm. Curing was effected at a tunnel temperature of 60 to 70° C. The heating time was 12 minutes (corresponds to crossover-time of G′ and G″).

The makeup of the polyurethane backing composition was as follows:

| | | Weight fraction |
|---|---|---|
| | Raw material | [% by weight] |
| A component | Arcol 1042 ® | 29.0 |
| | Dibutyltin dilaurate | 0.1 |
| | Omyacarb 4BG ® | 63.1 |
| | Calcium oxide | 5.0 |
| B component | Desmodur CD ® | 2.8 |

The resultant adhesive tape had a tensile strength of 9.8 N/mm² with an elongation at break of 18%. The bond strength on steel was 2.6 N/cm.

### Example 9

To produce an adhesive printing plate mounting strip for the printing industry, the process was used as follows:

1st Process Step (Preparation Step), Production of the Incoming Material 1:

A solvent-based acrylate pressure-sensitive adhesive composition consisting of ethylhexyl acrylate (70%), stearyl acrylate (17%), acrylic acid (3%), and known resins (10%) was applied in an application thickness of 60 g/m² to standard commercial double-sided release paper, dried and subsequently wound up.

2nd Process Step (Preparation Step), Production of the Incoming Material 2:

Process step 1 was repeated.

3rd Process Step, Polyurethane Coating:

Between the acrylate pressure-sensitive adhesive compositions from process steps 1 and 2, applied to the release papers, coating took place with a devolatilized, two-component polyurethane backing composition at a rate of 1 m/min. The application thickness was 1.5 mm. Curing was effected at a tunnel temperature of 90° C. The heating time was 14 minutes (corresponds to crossover-time of G′ and G″).

The makeup of the polyurethane backing composition was as follows:

| | | Weight fraction |
|---|---|---|
| | Raw material | [% by weight] |
| A component | Arcol 1042 ® | 41.0 |
| | Arcol 1043 ® | 41.0 |
| | Dibutyltin dilaurate | 0.2 |
| | Kronos 2160 ® | 1.6 |
| | Calcium oxide | 5.0 |
| | Aerosil R 202 ® | 3.5 |
| B component | Vestanat IPDI ® | 7.7 |

The resultant adhesive tape had a compressive strength H₁₄ of 22 N/cm². The bond strength on steel was 3.4 N/cm.

### Example 10

To produce a microballoon-foamed adhesive printing plate mounting strip for the printing industry, the process was used as follows:

1st Process Step (Preparation Step), Production of the Incoming Material 1:

A solvent-based acrylate pressure-sensitive adhesive composition consisting of ethylhexyl acrylate (70%), stearyl acrylate (17%), acrylic acid (3%), and known resins (10%) was applied in an application thickness of 60 g/m² to standard commercial double-sided release paper, dried and subsequently wound up.

2nd Process Step (Preparation Step), Production of the Incoming Material 2:

Process step 1 was repeated.

3rd Process Step, Polyurethane Coating:

Between the acrylate pressure-sensitive adhesive compositions from process steps 1 and 2, applied to the release papers, coating took place with a devolatilized, two-component polyurethane backing composition at a rate of 1 m/min. The application thickness was 1.5 mm. Curing was effected at a tunnel temperature of 90° C. The heating time was 14 minutes (corresponds to crossover-time of G′ and G″).

The polyurethane backing composition contained preexpanded thermoplastic hollow beads (Expancel®) and its makeup was as follows:

| | | Weight fraction |
|---|---|---|
| | Raw material | [% by weight] |
| A component | Arcol 1042 ® | 39.5 |
| | Arcol 1043 ® | 39.5 |
| | Dibutyltin dilaurate | 0.2 |
| | Kronos 2160 ® | 1.9 |
| | Calcium oxide | 5.0 |
| | Expancel 551 DE 80 ® | 3.0 |
| | Aerosil R 202 ® | 3.5 |
| B component | Vestanat IPDI ® | 7.4 |

The resultant adhesive tape had a compressive strength H₁₄ of 30 N/cm². The bond strength on steel was 2.9 N/cm.

### Example 11

To produce a nitrogen-foamed adhesive printing plate mounting strip for the printing industry, the process was used as follows:

1st Process Step (Preparation Step), Production of the Incoming Material 1:

A solvent-based acrylate pressure-sensitive adhesive composition consisting of ethylhexyl acrylate (70%), stearyl acrylate (17%), acrylic acid (3%), and known resins (10%) was applied in an application thickness of 60 g/m² to standard commercial double-sided release paper, dried and subsequently wound up.

2nd Process Step (Preparation Step), Production of the Incoming Material 2:

Process step 1 was repeated.

3rd Process Step, Polyurethane Coating:

Between the acrylate pressure-sensitive adhesive compositions from process steps 1 and 2, applied to the release papers, coating took place with a devolatilized, two-component polyurethane backing composition at a rate of 1 m/min. Nitrogen was introduced into the polyurethane backing composition directly at the mixing head, so that the cured backing had a density of 0.7 g/cm³. The application thickness was 1.5 mm. Curing was effected at a tunnel temperature of 90° C. The heating time was 14 minutes (corresponds to crossover-time of G′ and G″).

The makeup of the polyurethane backing composition was as follows:

| | | Weight fraction |
|---|---|---|
| | Raw material | [% by weight] |
| A component | Arcol 1030 ® | 17.0 |
| | Arcol 1067S ® | 40.0 |
| | Dibutyltin dilaurate | 0.2 |
| | Kronos 2160 ® | 2.4 |
| | Calcium oxide | 9.0 |
| | Aerosil R 202 ® | 3.5 |
| B component | Vestanat IPDI ® | 27.9 |

The resultant adhesive tape had a compressive strength H₁₄ of 28 N/cm². The bond strength on steel was 2.7 N/cm.

1. A process for continuous production of self-adhesive articles, wherein
a) a polyol component is placed in a container A and an isocyanate component is placed in a container B,
b) the polyol component and the isocyanate component are mixed in a mixer,
c) the polyurethane composition thus mixed is applied to a backing material which is coated with a pressure-sensitive adhesive composition and moves optionally at constant speed, the isocyanate component and polyol component reacting on the adhesive-coated backing material to form a polyurethane composition,
d) the resulting laminate, comprising first backing material, pressure-sensitive adhesive composition and polyurethane composition, is passed through a heat tunnel for a time which is less than that required for complete curing of the polyurethane, but sufficient for the curves of storage modulus (G′) and loss modulus (G″) of the polyurethane composition, as a function of curing time, to cross each other, and
e) the laminate is then wound in a winding station.

2. The process as claimed in claim 1, wherein a second backing material is applied to the polyurethane-forming reactive mixture on the first backing material and, optionally, is peeled off after the heating tunnel.

3. The process as claimed in claim 2, wherein the second backing material is treated with a pressure-sensitive adhesive composition.

4. The process as claimed in claim 1, wherein upstream of the mixer there are further containers for catalysts, plasticizers, dyes and other additives, which optionally are introduced and added.

5. The process as claimed in claim 1, wherein the polyurethane-forming reactive mixture is applied onto the pressure-sensitive adhesive composition.

6. The process as claimed in claim 2, wherein the first or second backing material used comprises a dehesive media.

7. A single- or double-sided self-adhesive tape obtained by the process of claim 1.
